(19) United States
(12) Patent Application Publication
(10) Pub. No.: US 2002/0140850 A1
(43) Pub. Date: Oct. 3, 2002

(54) Heavy duty pendant with dome guard for dome camera system

(75) Inventors: David L. A. Toste, Fresno, CA (US); Joshua Houser, Fresno, CA (US); Terrence J. Traser, Clovis, CA (US); Lolo Garza, Clovis, CA (US); Jimmy Lee Harris, Clovis, CA (US)

Correspondence Address: MARK D MILLER, KIMBLE, MACMICHAEL & UPTON, 5260 NORTH PALM AVENUE, SUITE 221, FRESNO, CA, 93704, US

(73) Assignee: Pelco

(21) Appl. No.: 10/107,673

(22) Filed: Mar. 26, 2002

Related U.S. Application Data
(63) Continuation-in-part of application No. 29/139,519, filed on Mar. 30, 2001, now Pat. No. D457904.
(63) Continuation-in-part of application No. 29/139,492, filed on Mar. 29, 2001, now Pat. No. D460978.
(60) Provisional application No. 60/280,445, filed on Mar. 29, 2001.
(60) Provisional application No. 60/280,716, filed on Mar. 30, 2001.

(51) Int. Cl. H04N 5/225

(52) U.S. Cl. 348/375

(57) ABSTRACT

A protective guard for the transparent dome of a surveillance camera system deployed in a harsh or dangerous outdoor environment. The guard is a hemispherically shaped metallic unit that covers the dome with a series of longitudinal arcuate ribs originating at the equator of the hemisphere and terminating at an open circle at the pole. The guard may be deployed on a surface-mounted dome having an upward, downward or sideways orientation, or it may be deployed on a heavy-duty dangling pendant enclosure. The pendant embodiment includes weather-resistant features including air insulation around the internal components, and slots that allow for the passage of fluid through the pendant for removal of moisture, cooling and evaporation.

This application claims the benefit of U.S. provisional application No. 60/280,445 filed on Mar. 29, 2001, of U.S. provisional patent application No. 60/280,716 filed on Mar. 30, 2001, of U.S. design patent application No. 29/139,519 filed on Mar. 30, 2001, and of U.S. design patent application No. 29/139,492 filed on Mar. 29, 2001.

### BACKGROUND OF THE INVENTION

1. Field of the Invention

The present invention relates to surveillance camera systems, and more particularly to a housing for a surveillance camera in the form of a heavy-duty pendant that may be provided in conjunction with a guard for protecting the transparent dome that encloses the surveillance camera.

2. Description of the Prior Art

The use of surveillance cameras and related systems is becoming increasingly more prevalent. Not only are surveillance cameras used in such traditional institutions as banks and casinos, but their use has spread to retail and business establishments, indoor and outdoor entry points, airport security checkpoints, government buildings, and the like.

In the field of surveillance cameras, it is often desirable for the camera to be mounted in an inverted position such as hanging from a ceiling, or underneath an eave. In these situations, it is typical to deploy the camera inside an inverted transparent dome structure. This allows the camera to be able to spin (pan) through a full 360 degrees of view, and tilt through a full 180 degrees of view, if not more. However, in many instances, there is no available ceiling, eave or other surface upon which to mount the inverted camera enclosure. In these situations, the inverted camera is typically housed in a dangling enclosure having a transparent dome at the bottom that hangs from a pole, arm or other support structure. In many cases, both surface mounted and dangling surveillance cameras and enclosures must be installed in locations that are outdoors or in remote or unattended areas. Such deployment may subject the enclosure, dome and camera to damage from climactic conditions and/or vandalism.

Existing surveillance camera enclosures are not properly suited for such rugged deployment. Ceiling mounted dome and spherical structures such as those described in U.S. Pat. Nos. 3,638,502; 3,720,147; 3,732,368 and 3,739,703 are largely designed for indoor deployment and use. Some existing enclosures such as those described in U.S. Pat. Nos. 4,833,534 and 4,764,008 describe shutters or slots in the dome to limit exposure of the camera. These slots add unnecessary complexity and mechanics to the enclosure, and tend to limit the viewing scope of the camera itself. A dome and slot configuration for outdoor use is disclosed in U.S. Pat. No. 4,984,089. Other outdoor enclosures are disclosed in U.S. Pat. Nos. 5,689,304; 6,061,087; Des. 414,504; Des. 415,509 and Des. 424,087. However, the transparent domes of all of these structures and the delicate cameras deployed therein remain exposed to damage from climactic conditions and vandalism.

Protective enclosures in the form of cages for outdoor lights and light bulbs have also been developed, as disclosed in U.S. Pat. Nos. 3,826,912; 4,791,541 and Des. 439,697. However, the width and placement of the cage elements of these enclosures are not compatible for use with a surveillance camera in that significant portions of the available view would be obscured by these elements, particularly the area directly below the camera where the cage members cross in an X or plus sign (+) pattern.

It is therefore desirable to provide a secure, strong and insulated protection system for a surveillance camera and the transparent dome surrounding it for use in a surface-mounted or pendant-mounted outdoor enclosure which does interfere with the viewing capability of the camera inside.

### SUMMARY OF THE INVENTION

The present invention provides a protective enclosure for the transparent dome of a surveillance camera system deployed in a potentially harsh or dangerous outdoor environment in the form of a hemispherically shaped metallic guard for covering the dome defined by a series of longitudinal arcuate ribs originating at the equator of the hemisphere and terminating at an open circle at the pole. The guard may be deployed on a surface-mounted dome having an upward, downward or sideways orientation, or it may be deployed on a heavy-duty dangling pendant enclosure. The pendant includes weather-resisting features including air insulation around the internal components, and slots that allow for the passage of fluid through the pendant for removal of moisture, cooling and evaporation.

The guard of the present invention is deployed in close proximity to the dome it covers, and includes a plurality of thin elliptically shaped ribs, with a circular opening at the bottom. The closeness of the ribs of the guard avoid impairment of the viewing ability of the camera because the focal point for the camera will ordinarily be outside of the dome and the guard structure. The thin or narrow cross section of the ribs together with their elliptical shape minimizes the amount of viewing area affected. Thus, the closely deployed thin ribs have almost no effect on the viewing capabilities of the camera. An open circular structure is provided at the bottom or end of the guard for attachment to the several ribs. This opening provides the camera with a clear view when pointed directly out or down, unimpaired by any intersection of the ribs with each other at this outermost point.

In one aspect of the invention, the dome guard may deployed on a surface-mounted dome that may be attached to a ceiling, wall, floor or other suitable surface.

In another aspect of the invention, a heavy-duty pendant structure is provided having a downwardly pointing dome over which the guard of the present invention is deployed. The inverted pendant provides a cavity of air inside the pendant-dome assembly around the entire camera system, providing a layer of insulation. A series of slots allows passage of fluid (i.e. air or water) from the top of the system through the bottom, or vice versa. These slots improve drainage during rainy weather, and allow air to flow through to evaporate and cool during dry weather.

It is therefore a primary object of the present invention to provide a protective guard for the transparent dome surrounding the camera of a surveillance camera system to protect the dome and the camera therein from climactic exterior conditions or vandalism.

It is also a primary object of the present invention to provide a protective guard for the dome of a surveillance camera system that does not interfere with the view of the camera deployed inside the dome.

It is also an important object of the present invention to provide a protective guard for the dome of a surveillance camera system that may be used on a surface-mounted camera enclosure that is deployed in a harsh exterior environment.

It is another important object of the present invention to provide a protective guard for the dome of a surveillance camera system that may be used on a pendant-mounted camera enclosure that is deployed in a harsh exterior environment.

It is another object of the present invention to provide a heavy-duty pendant enclosure for a surveillance camera system having air insulating and water repellant capabilities.

Additional objects of the invention will be apparent from the detailed descriptions and the claims herein.

### BRIEF DESCRIPTION OF THE DRAWINGS

FIG. 1 is a side view of the pendant and dome guard of the present invention.

FIG. 2 is a sectional view along line 2—2 of FIG. 1 showing the camera works deployed inside.

FIG. 3 is an inside view of the bottom of the dome of the present invention, with a guard installed.

FIG. 4 is an outside view of the bottom of the dome of the present invention, with a guard installed.

FIG. 5 is another outside view of the bottom of the dome of the present invention, with a guard installed.

FIG. 6 is an inside view of the bottom of the dome of the present invention, with no guard installed.

FIG. 7 is an outside view of the bottom of the dome of the present invention, with no guard installed.

FIG. 8 is another outside view of the bottom of the dome of the present invention, with no guard installed.

FIG. 9 is a back perspective view of the pendant of the present invention, with no guard installed.

FIG. 10 is a front perspective view of the pendant of the present invention, with no guard installed.

FIG. 11 is a front perspective view of the pendant of the present invention, with no guard installed.

FIG. 12 is a back perspective view of the pendant of the present invention, with a guard installed.

FIG. 13 is a front perspective view of the pendant of the present invention, with a guard installed.

FIG. 14 is a front perspective view of the pendant of the present invention, with a guard installed.

FIG. 15 is a perspective view of the dome guard of the present invention attached to an annular surface mount.

FIG. 16 is a perspective view of the dome guard of the present invention attached to an annular surface mount with an annular cover over the mount.

FIG. 17 is a perspective view of the invention shown in FIG. 15 attached to a recessed back (e.g. ceiling) box.

FIG. 18 is a perspective view of the invention attached to a back box with annular mount and cover.

FIG. 19 is a side elevational view of the dome of the present invention.

FIG. 20 is a sectional view along line A—A of FIG. 19.

FIG. 21 is a bottom view of the dome of present invention.

FIG. 22 is a outside perspective view of the dome of the present invention.

FIG. 23 is an inside perspective view of the dome of the present invention.

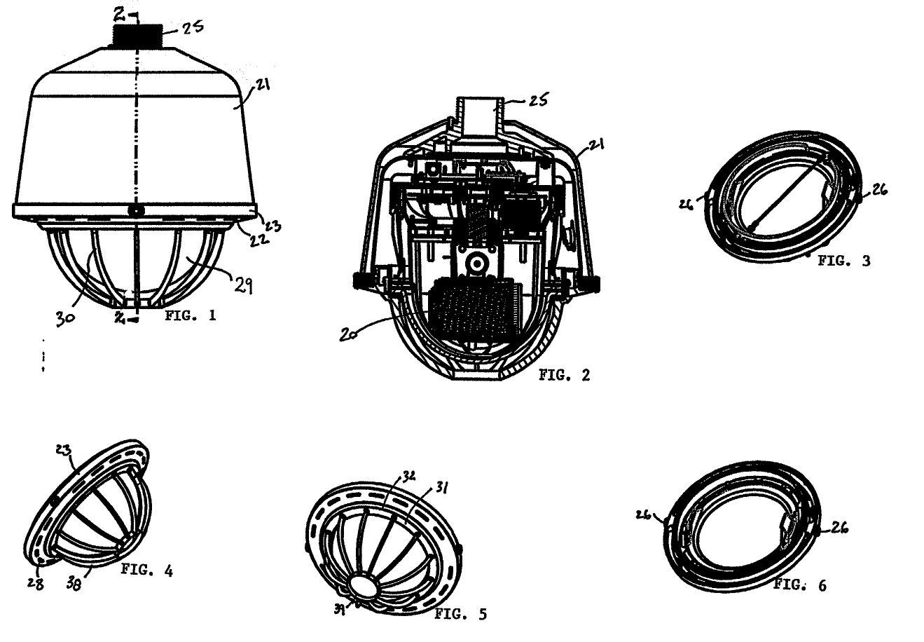

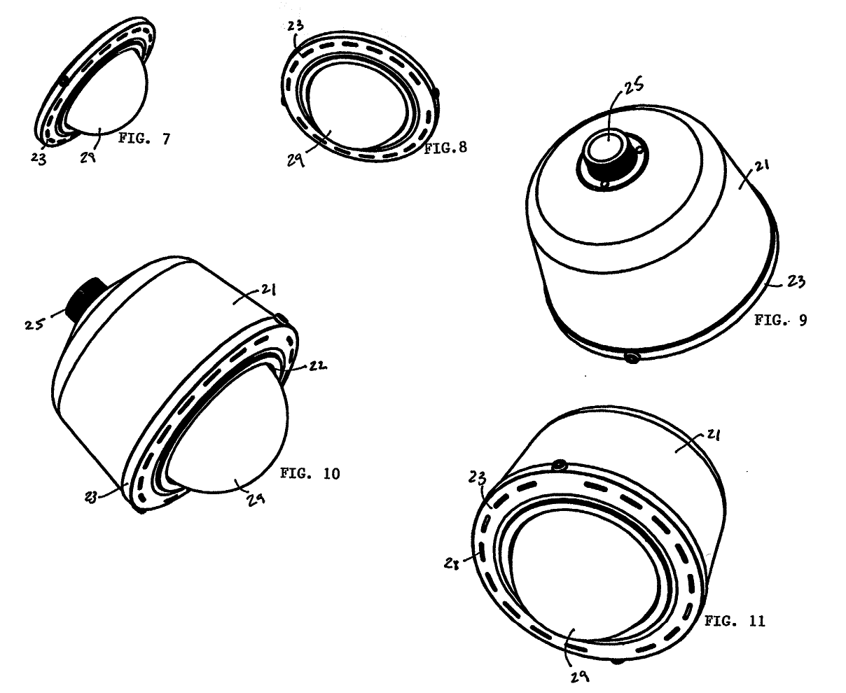

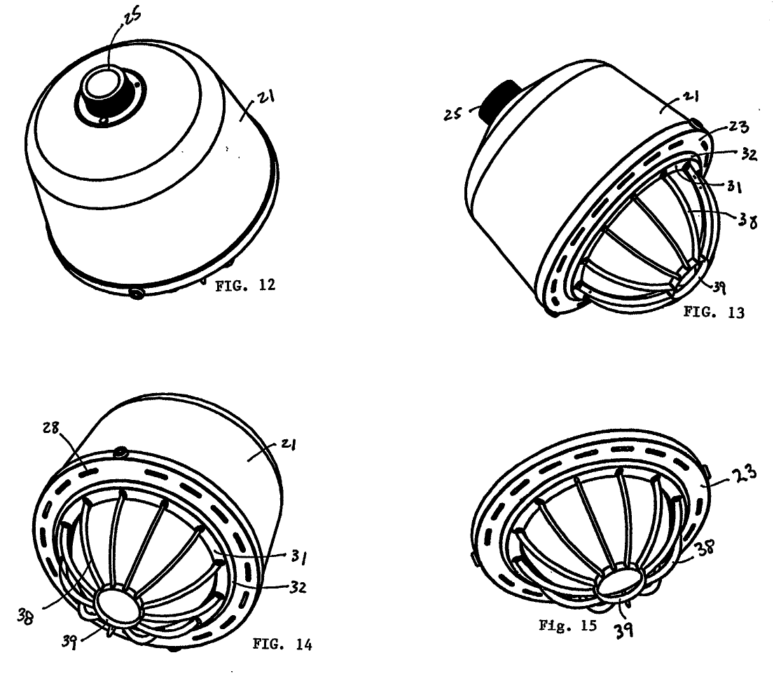

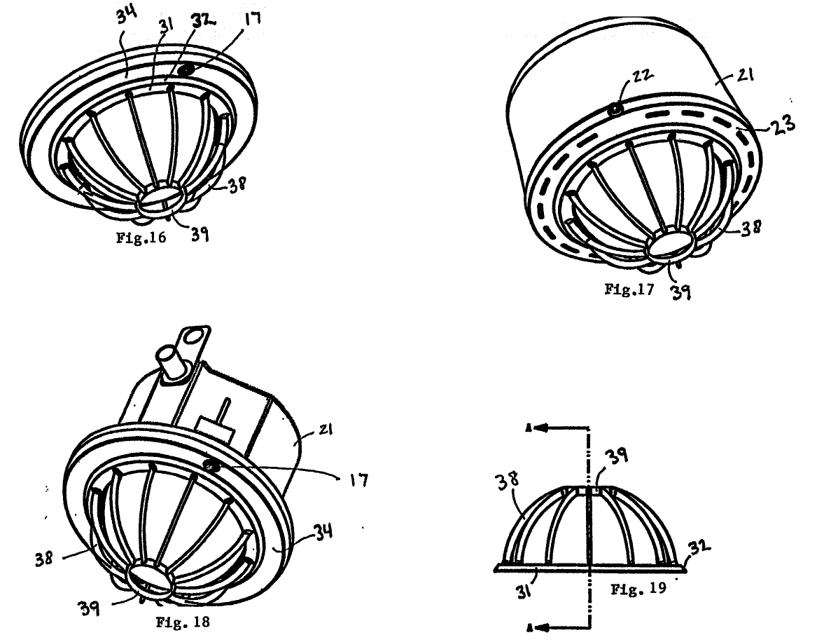

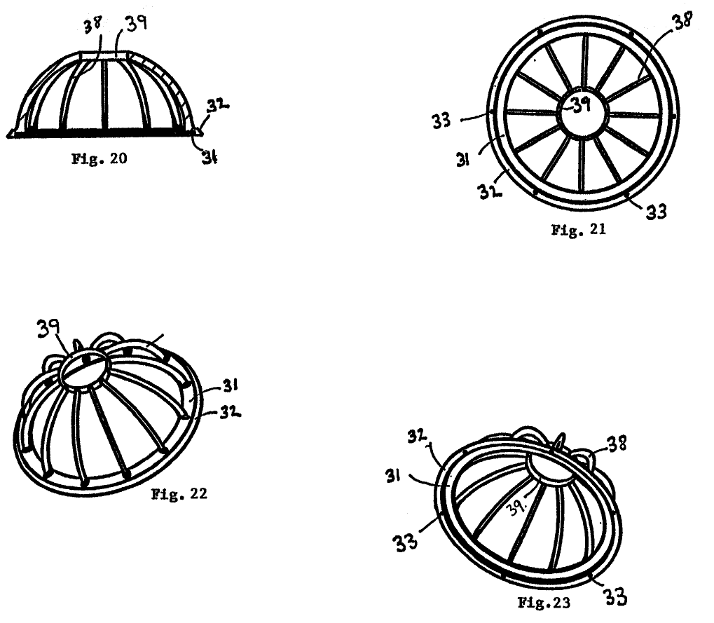

### DETAILED DESCRIPTION OF A PREFERRED EMBODIMENT

Referring to the drawings wherein like reference characters designate like or corresponding parts throughout the several views, it is seen that the pendant of the present invention includes a generally cylindrical, tapered housing cup 21 having a central mounting bracket 25 located at its closed end, and an annular opening 22 for receiving a transparent dome 29 at the opposite end. Pendant cup 21 is designed for installation in an inverted position with bracket 25 at the top. A surveillance camera and its related operation works (lenses, electronics, motors, gears, etc.) are deployed inside cup 21, with camera 20 protruding below annular opening 22. Dome 29 hangs from an annular bracket 23 around opening 22.

The dome guard 30 of the present invention has an annular base 31 having an outer annular lip 32 that is provided for attachment to a camera housing such as cup 21 using bracket 23. A plurality of longitudinal arcuate ribs 38 are provided in guard 30 which originate from base 31 and extend to an upper open circle 39. Base 31 is designed to be attached to annular mounting bracket 23 using screws, rivets or other attachment devices inserted through a plurality of tap openings 33 in the back of base 31 as shown in FIGS. 15 and 21. Bracket 23, in turn, is designed to be attached to a camera enclosure such as a recessed back box 21 (mounted above the ceiling, behind the wall, etc.) which holds the camera works. Attachment is accomplished using screws, rivets or other attachment devices 22, as shown in FIGS. 17 and 18. A cover 14 is provided for covering bracket 23 and lip 32 as shown in FIG. 16. Cover 14 is attached using screws, rivets or other attachment devices 17.

Guard 30 of the present invention closely surrounds the transparent dome 29 enclosing the camera 20 with elliptical ribs 38 having a thin cross section as shown in FIG. 21. The closeness of the guard 30 coupled with the thin, elliptical shapes of the ribs 38 avoid impairing the viewing ability of the camera since the optical focal point of the camera is outside and beyond the guard. Similarly, circle 39 at the end of the guard 30 is open allowing the camera 20 to view through the end of the guard 30 to see the area directly out from the camera (e.g. directly below a ceiling-mounted camera).

The hemispherical shape of guard 30 provides a strong and sturdy structure capable of withstanding impacts from foreign objects, including branches or debris kicked up by high winds, or rocks or other objects propelled with intent to vandalize. Guard 30 can be made of any durable non-corrosive material including without limitation stainless steel, aluminum alloy, durable plastic or other ferrous material. The guard should be dark in color (e.g. gray or black) since lighter colors (e.g. white) tend to be reflective and can have an effect on the video of the camera. Guard 30 is easily removed and installed which aids in the cleaning of the guard and the exterior of the transparent dome itself.

When dome 29 and guard 30 are attached to a dangling pendant 21, gravity causes them to bottom out on the horizontal surface of the thicker outer weather shield. This creates a 360 degree cavity of air inside the pendant-dome assembly around the entire camera system, providing a layer of insulation. A series of slots 28 in the trim ring assembly 23 allows passage of fluid (i.e. air or water) from the top of the system through the bottom, or vice versa. This improves drainage during rainy weather, and allows air to flow through to evaporate and cool during dry weather. The trim ring assembly 23 locks into the pendant cup 21 with two key push pin type locks 26, 180 degrees offset, on trim ring 23. When the pins 26 are locked, the trim ring's gasket and upper horizontal surface interfere with any movement form an outside influence, thereby strengthening the entire system.

Thus, the present invention provides improved security through locks 26, insulation, drainage and air flow through the 360 degree air cavity, and added strength through the attachment of dome guard 30 to the strong pendant assembly 21.

It is to be appreciated that the size, shape and configuration of cup 21, as well as the position, deployment and location of guard 30, ribs 38 and opening 39 may all be changed or adjusted depending on the conditions and camera used; and that such features may be used in any combination with each other, or some features eliminated, without departing from the scope hereof.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A guard for the dome of a surveillance camera enclosure comprising a rigid semi-circular cage comprising a plurality of longitudinal arcuate ribs forming a hemisphere, each of said ribs originating at an annular equator member of the hemisphere and terminating at an open circular member at a pole thereof.

2. The guard of claim 1 wherein each of the ribs and the open circular member of said guard have a thin cross-section.

3. The guard of claim 1 wherein the ribs, equator member and open circular member of said guard are dark in color.

4. The guard of claim 2 wherein the ribs, equator member and open circular member of said guard are dark in color.

5. The guard of claim 1 wherein said ribs and said open circular member are deployed in close proximity around said dome.

6. The guard of claim 2 wherein said ribs and said open circular member are deployed in close proximity around said dome.

7. The guard of claim 3 wherein said ribs and said open circular member are deployed in close proximity around said dome.

8. The guard of claim 4 wherein said ribs and said open circular member are deployed in close proximity around said dome.

9. A guard for protecting a transparent dome surrounding a surveillance camera comprising a plurality of longitudinal arcuate ribs forming a sturdy hemispherically-shaped cage, each of said ribs originating at an annular equator member of the cage and terminating at an open circular member at a pole thereof.

10. A pendant for enclosing a surveillance camera system comprising: a generally cylindrical tapered housing cup having open and closed ends, a central mounting bracket located at the closed end, an annular opening for receiving a transparent dome at the open end, and a guard for protecting a transparent dome having a plurality of longitudinal arcuate ribs forming a sturdy hemispherically-shaped cage, each of said ribs originating at an annular equator member of the cage and terminating at an open circular member at a pole of said cage.

11. The pendant of claim 10 wherein an air envelope is provided inside said pendant between the housing cup and the internal surveillance camera system.

12. The pendant of claim 11 wherein a plurality of openings are provided in said cup to allow fluid to flow through said air envelope.
